(19) United States
(12) Patent Application Publication
(10) Pub. No.: US 2025/0095127 A1
(43) Pub. Date: Mar. 20, 2025

(54) DEFECT INSPECTION DEVICE, DEFECT INSPECTION METHOD, AND PREDICTION MODEL GENERATION METHOD

(71) Applicant: KABUSHIKI KAISHA F.C.C., Shizuoka (JP)

(72) Inventor: Motoki OKAZAKI, Shizuoka (JP)

(73) Assignee: KABUSHIKI KAISHA F.C.C., Shizuoka (JP)

(21) Appl. No.: 18/580,902

(22) PCT Filed: Aug. 1, 2022
(86) PCT No.: PCT/JP2022/029449

§ 371 Date: Jan. 19, 2024

(30) Foreign Application Priority Data
Sep. 1, 2021 (JP) 2021-142656

(51) Int. Cl. G06T 7/00; G06V 10/774; G06V 20/70

(52) U.S. Cl. CPC G06T 7/0004; G06V 10/774; G06V 20/70; G06T 2207/20081; G06T 2207/30108; G06V 2201/06

(57) ABSTRACT

As training data that is used in generation of a prediction model, training data for a normal product which is configured by assigning a normal product ground truth label including only a normal label indicating a possibility of correspondence to a normal product to a learning image of the normal product, and training data for a defective product which is configured by assigning a defective product ground truth label including only a plurality of weighted defect type labels indicating a possibility of correspondence to a plurality of defect types to a learning image of the defective product are used. According to this, it is possible to perform defect inspection with the prediction model in which a possibility of erroneously predicting the defective product as the normal product is further reduced by setting a loss value in a case of prediction as the normal product from a learning image of the defective product to which the defective product ground truth label is assigned to be larger than a loss value in a case of prediction as the defective product in a defect type other than a ground truth from the same learning image in machine learning.

### TECHNICAL FIELD

The present invention relates to a defect inspection device, a defection inspection method, and a prediction model generation method which are particularly suitable for a device and a method which perform defect inspection by using a learning model generated by machine learning.

### BACKGROUND ART

In the related art, there is known a system that determines presence or absence of a defect on the basis of a captured image of an object to be inspected by using a learning model generated by machine learning (for example, refer to PTL 1 and PTL 2). In an inspection device described in PTL 1, one or more defect candidates are extracted on the basis of a predetermined feature amount in a captured image of an object to be inspected, and with respect to determination regions including the extracted defect candidate, presence or absence of a defect is determined by using a learning model that is constructed by machine learning. In addition, in a case where it is determined that a defect is present in any one of the determination regions, a signal indicating presence of the defect is output, and in a case where it is determined that a defect is absent in all of the determination regions, a signal indicating absence of the defect is output. In an image evaluation device described in PTL 2, a determination is made on not only presence and absence of a defect but also the type of the defect.

The learning model described in PTL 1 is generated by supervised learning using a plurality of pieces of training data configured by assigning a ground truth label of “presence of a defect” to an image including a defect, and a ground truth label of “absence of a defect” to an image that does not include a defect. In addition, information indicating presence/absence of a defect is obtained as an output from the learning model by inputting a captured image of an object to be inspected to the learning model generated as described above. A learning model described in PTL 2 is generated by supervised learning using a plurality of pieces of training data configured by assigning a defect type to an image in which the type of the defect is known already as the ground truth label.

In a case of performing inspection of a defect by using a machine-learned learning model, if a captured image of an object to be inspect is the same as an image that is used training data, it is possible to obtain a correct inspection result. However, typically, the captured image of the object to be inspect is never exactly the same as the image that is used as the training data. In this case, since a determination is made by probability calculation based on the degree of approximation between a feature extracted from the captured image of the object to be inspected, and a feature (a feature recorded in the learning model) extracted from the training data, it cannot be said that a correct inspection result is obtained always.

Due to the nature of the defect inspection, it is required to minimize false recognition of false negative in which a defective product is determined as a normal product (a case where the product is determined to be negative in the inspection but is actually positive) as much as possible (decreasing false negative rate or increasing reproducibility (also referred to as sensitivity)). That is, it is desired that the learning model has the ability to detect a “suspected defect” as a defect. However, the learning models described in PTL 1 and PTL 2 have the following problem. Specifically, false recognition of false negative in which a defective product is determined as a normal product, and false recognition of false positive in which a normal product is determined as a defective product (the product is determined to be positive in the inspection but is actually negative) may occur to the same extent.

Note that, there is also known a classification device that generates training data by giving information of a ground truth category of a defect type to which a defective region is classified, and a confidence level that is a criterion of validity for the ground truth category with respect to the defective region (a region estimated to have a defect) extracted from a sample image, and determines a type of the defect included in the defective region extracted from an image of an object to be inspected by using the training data generated as described above (for example, refer to PTL 3). PTL 3 also discloses that with respect to one defective region, a plurality of defect types are provided as the ground truth category, and a weight is assigned to each ground truth category in correspondence with the confidence level.

In the classification device described in PTL 3, since training data in which the weight is set with respect to the type of the defect is generated, it is possible to improve accuracy of classification into a defect type. However, in the classification device described in PTL 3, the training data in a table type is generated for the defective region extracted by subjecting an inspection image to image analysis, and classification of the defect type is performed by comparison with the training data. That is, the classification device described in PTL 3 does not make determinations on the defect type which include a determination as to whether the product is a normal product or a defective product on the basis of a machine-learned learning model. Therefore, even when using the technology described in PTL 3, in a case of performing defect inspection on the basis of the learning model, it is difficult to reduce false recognition of false negative in which a defective product is determined as a normal product.
PTL 1: JP2021-110629A
PTL 2: JP2020-119135A
PTL 3: JP4050273B

### SUMMARY OF INVENTION

### Technical Problem

The invention has been made to solve the problem, and an object thereof is to reduce false recognition of false negative in which a defective product is determined as a normal product as much as possible in a system that conducts inspection of a defect by using a learning model generated by machine learning.

### Solution to Problem

To solve the problem, in the invention, prediction as to whether an object to be inspected is a normal product and prediction of a defect type in a case where the object to be inspected is a defective product are performed by applying an inspection image that is a captured image of the object to be inspected to a prediction model that is trained by using training data. The training data is configured by assigning a normal product ground truth label that does not include a label indicating a possibility of correspondence to a defective product and includes only a normal label indicating a possibility of correspondence to a normal product to a learning image of the normal product, and by assigning a defective product ground truth label that does not include a normal label indicating a possibility of correspondence to the normal product and includes a plurality of defective type labels indicating a possibility of correspondence to a plurality of defect types, and a defective product ground truth label including a weight for each of the defect type labels to a learning image of a defective product.

### Advantageous Effects of Invention

When performing machine learning of the prediction model by using the training data configured as described above, a loss value in a case of prediction as the normal product from a learning image of the defective product to which the defective product ground truth label is assigned becomes larger than a loss value in a case of prediction as the defective product in a defect type other than a ground truth from the same learning image. Since the prediction model is machine-learned to minimize the loss value, it is possible to further reduce a possibility of erroneously predicting the defective product as the normal product. As described above, according to the invention, in a system that conducts defect inspection by using the learning model that is generated by machine learning, it is possible to reduce false recognition of false negative in which the defective product is determined as the normal product as much as possible.

### BRIEF DESCRIPTION OF DRAWINGS

FIG. 1 is a block diagram illustrating a functional configuration example of a defect inspection device according to this embodiment.

FIG. 2 is a view schematically illustrating an inspection image that is set as a processing target in this embodiment.

FIG. 3 is a view schematically illustrating a normal product ground truth label and a defective product ground truth label of this embodiment.

FIG. 4 is a block diagram illustrating a functional configuration example of a prediction model generation device according to this embodiment.

FIG. 5 is a flowchart illustrating an operation example of the prediction model generation device according to this embodiment.

FIG. 6 is a flowchart illustrating an operation example of the defect inspection device according to this embodiment.

### DESCRIPTION OF EMBODIMENTS

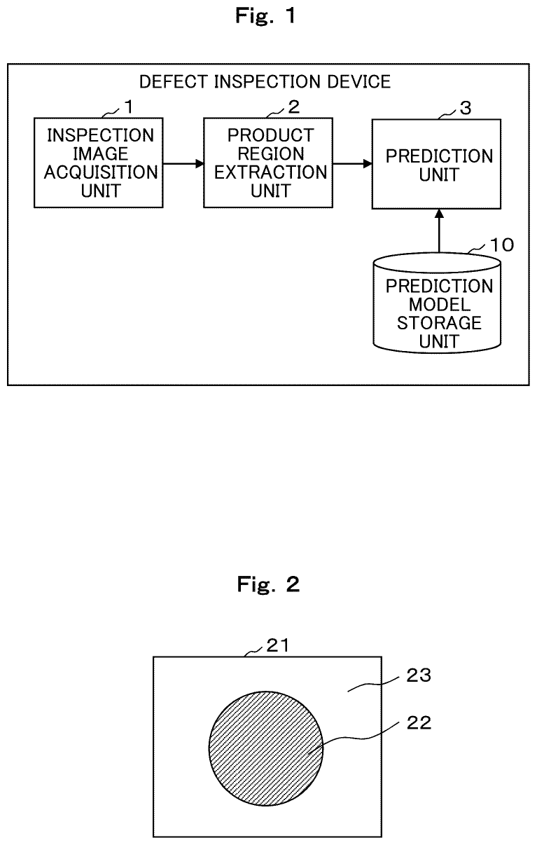

Hereinafter, an embodiment of the invention will be described with reference to the accompanying drawings. FIG. 1 is a block diagram illustrating a functional configuration example of a defect inspection device according to this embodiment. As illustrated in FIG. 1, the defect inspection device of this embodiment includes an inspection image acquisition unit 1, a product region extraction unit 2, and a prediction unit 3 as a functional configuration. In addition, the defect inspection device of this embodiment includes a prediction model storage unit 10 as a storage medium.

Each of the functional blocks 1 to 3 can be configured by any one of hardware, a digital signal processor (DSP), and software. For example, when being configured by software, each of the functional blocks 1 to 3 actually includes a CPU, a RAM, a ROM, and the like of a computer, and is realized through an operation of a program stored in a recording medium such as the RAM, the ROM, a hard disk, or a semiconductor memory. Instead of the CPU or in addition to the CPU, a graphics processing unit (GPU), a field programmable gate array (FPGA), an application specific integrated circuit (ASIC), or the like may be used.

The inspection image acquisition unit 1 acquires a captured image (hereinafter, referred to as an inspection image) of an object to be inspected. The object to be inspected is a target for which presence or absence of a defect, and a defect type are inspected, and is, for example, a specific product. Before shipping a product manufactured in a factory or the like, it is required to determine whether a defect is present in the product, and to specify a defect type in a case where the defect is present. The product that is set as an inspection target in this case is the object to be inspected in this embodiment.

The captured image of the object to be inspected is an image obtained by imaging the object to be inspected by a camera from a predetermined position under predetermined imaging conditions. For example, the object to be inspected is moved to a predetermined imaging position by a conveying mechanism such as a belt conveyor, and the object to be inspected is imaged by a camera installed at the imaging position. The inspection image acquisition unit 1 acquires an inspection image captured by the camera for each of a plurality of products at any time. FIG. 2 is a view schematically illustrating an inspection image that is set as a processing target in this embodiment. An inspection image 21 illustrated in FIG. 2 shows a state in which a circular product in front view is imaged from a front side as a front view, and includes a product region 22 and a background region 23 other than the product.

The product region extraction unit 2 extracts the product region 22 from the inspection image 21 acquired by the inspection image acquisition unit 1. In extraction of the product region 22, a known method can be used. For example, the product region extraction unit 2 performs processing of extracting a contour of an object by analyzing the inspection image 21, and can extract a closed region surrounded by the contour as the product region 22. Since a shape of the product that is set as the inspection target is fixed (a circular shape in a case of FIG. 2), a contour having a predetermined shape may be extracted. Note that, since the contour is likely to be exactly extracted as a difference between the product region 22 and the background region 23 is larger, it is preferable to perform imaging of the object to be inspected under conditions of increasing the difference.

An image of the product region 22 extracted by the product region extraction unit 2 is input to the prediction unit 3. Note that, in description of the prediction unit 3, an inspection image represents an image of the product region 22 extracted by the product region extraction unit 2 instead of the entirety of the inspection image 21 shown in FIG. 2.

The prediction unit 3 applies the inspection image that is acquired by the inspection image acquisition unit 1, specifically, the image obtained by extracting the product region 22 by the product region extraction unit 2 to a prediction model trained by training data, and performs prediction as to whether the object to be inspected is a normal product, and prediction of a defect type in a case where the object to be inspected is a defective product. The trained prediction model is stored in the prediction model storage unit 10 in advance.

In this embodiment, the training data that is used in machine-learning of the prediction model has the following characteristics. The training data is data configured by assigning a ground truth label indicating ground truth regarding presence or absence of a defect and a defect type to the captured image (hereinafter, referred to as a learning image) of the product for which presence or absence of a defect and a defect type are known. In the training data that is used in this embodiment, a method of providing a ground truth label is different between a ground truth label that is assigned to a learning image of a normal product with no defects, and a ground truth label that is assigned to a learning image of a defective product with any one type of defect. That is, a method of providing the ground truth label to the learning image of the normal product, and a method of providing the ground truth label to the learning image of the defective product are asymmetric to each other.

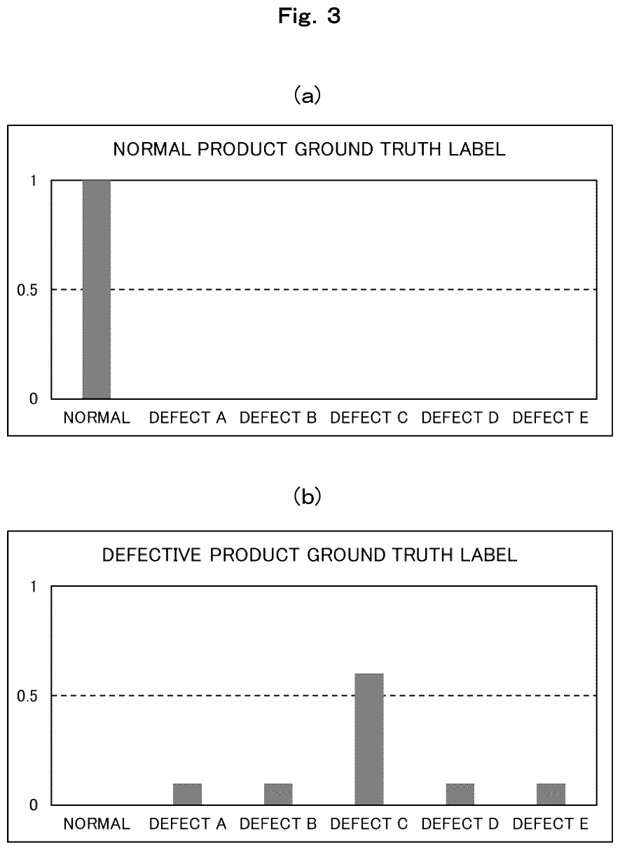

FIG. 3 is a view schematically illustrating the ground truth label that is assigned to the learning image of the normal product (FIG. 3(a)), and the ground truth label that is assigned to the learning image of the defective product (FIG. 3(b)). As illustrated in FIG. 3(a), the training data relating to the normal product is configured by assigning the normal product ground truth label that does not include a label indicating a possibility of correspondence to the defective product and includes only a normal label indicating a possibility of correspondence to the normal product to the learning image of the normal product. That is, with regard to the learning image of the normal product, only a normal label of a maximum weight (for example, 1.0) is assigned to definitively indicate that the product is a normal product, and a ground truth label that does not include any defect type label indicating a possibility of presence of any one of defect types A to E is assigned as the normal product ground truth label.

On the other hand, as illustrated in FIG. 3(b), the training data relating to the defective product is configured by assigning a defective product ground truth label that does not include the normal label indicating a possibility of correspondence to the normal product and includes a plurality of defect type labels indicating a possibility of correspondence to a plurality of defect types A to E and a weight for each of the defect type labels to the learning image of the defective product. That is, with regard to the learning image of the defective product, the plurality of defect type labels to which a weight less than the maximum weight is set is assigned to indicate the possibility that the product is a defective product having a defect of any one of the defect types A to E, and a ground truth label that does not include the normal label indicating the possibility of the normal product is assigned as the defective product ground truth label. For example, values of the weight assigned to the plurality of defect type labels are set so that the sum of the values becomes the maximum weight (1.0).

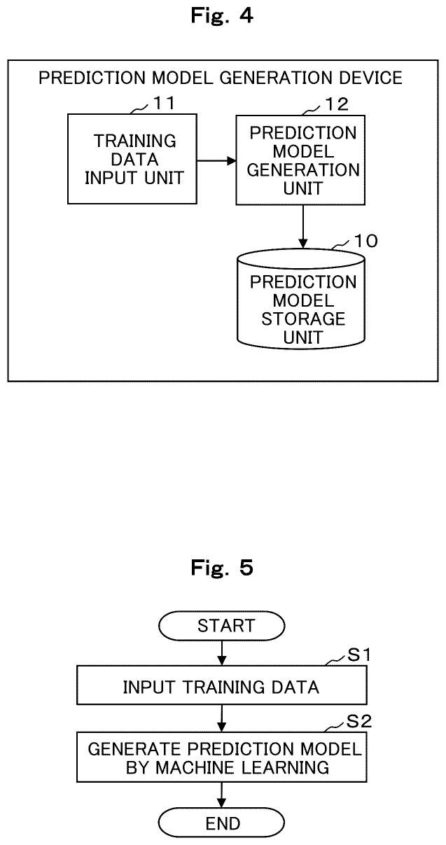

FIG. 4 is a block diagram illustrating a functional configuration example of a prediction model generation device that generates a prediction model by using the training data having a configuration illustrated in FIG. 3. As illustrated in FIG. 4, the prediction model generation device of this embodiment includes a training data input unit 11 and a prediction model generation unit 12 as a functional configuration. The functional blocks 11 and 12 can also be configured by any of hardware, DSP, and software in a similar manner as in FIG. 1. FIG. 5 is a flowchart illustrating an operation example when the prediction model is generated by the prediction model generation device illustrated in FIG. 4. Hereinafter, a prediction model generation method will be described with reference to FIG. 4 and FIG. 5.

The training data input unit 11 inputs a plurality of pieces of training data to which the ground truth label illustrated in FIG. 3 is assigned (step S1). The plurality of pieces of training data that is input is a data set including training data relating to a plurality of normal products to which the normal product ground truth label illustrated in FIG. 3(a) is assigned, and training data relating to a plurality of defective products to which the defective product ground truth label illustrated in FIG. 3(b) is assigned.

The prediction model generation unit 12 performs machine learning processing by using the training data input by the training data input unit 11 to generate a prediction model for outputting a prediction result as to whether the object to be inspected is a normal product and a prediction result of a defect type in a case where the object to be inspected is a defective product when the inspection image that is a captured image of the object to be inspected is input (step S2). The prediction results output by the prediction model are information including the possibility that the object to be inspected is the normal product, or the probability indicating the possibility of having defects of the defect types A to E (any one value among 0 to 1.0 for normal product and each of the defect types A to E).

The prediction model generation unit 12 calculates a loss value based on the prediction results from the learning image of the training data, and the ground truth label (any one of the normal product ground truth label and the defective product ground truth label) attached to the learning image, and updates various parameters of the prediction model to minimize the loss value. Here, also when performing prediction from the learning image, as in the product region extraction unit 2, the product region 22 is extracted from the learning image, and prediction is performed by setting an image of the product region 22 as a target. The prediction model generation unit 12 stores the prediction model generated in this manner in the prediction model storage unit 10.

In this embodiment, since the training data to which the ground truth labels asymmetric between the learning image of the normal product and the learning image of the defective product is set is used, a loss value in a case of prediction as a normal product from the learning image of the defective product to which the defective product ground truth label in which any one defect type is set as a ground truth (the largest weight is set to any one defect type) is assigned becomes larger than a loss value in a case of prediction as a defective product in a defect type other than the ground truth from the learning image of the defective product to which the same defective product ground truth label is assigned. Since the prediction model is machine-learned to minimize the loss value, it is possible to construct a prediction model in which a possibility of erroneously predicting the defective product as the normal product is lower.

Note that, the form of the prediction model that is generated in this embodiment can be set to any one among a regression model, a tree model, a neural network model, a Bayesian model, a clustering model, and the like. However, the form of the prediction model exemplified here is illustrative only, and is not limited thereto.

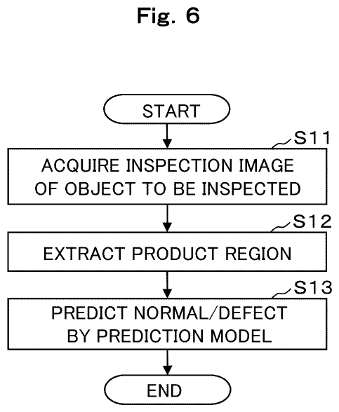

FIG. 6 is a flowchart illustrating an operation example when performing defect inspection of an object to be inspected by the defect inspection device illustrated in FIG. 1. First, the inspection image acquisition unit 1 acquires an inspection image that is a captured image of the object to be inspected (step S11). Then, the product region extraction unit 2 extracts the product region 22 from the inspection image 21 acquired by the inspection image acquisition unit 1 (step S12).

Next, the prediction unit 3 applies the inspection image of the product region 22 extracted by the product region extraction unit 2 to a trained prediction model stored in the prediction model storage unit 10, and performs prediction as to whether the object to be inspected is a normal product and prediction of a defect type in a case where the object to be inspected is a defective product (step S13).

As described above in detail, in this embodiment, as the training data that is used in generation of the prediction model, training data for a normal product which is configured by assigning a normal product ground truth label including only a normal label indicating a possibility of correspondence to a normal product to a learning image of the normal product, and training data for a defective product which is configured by assigning a defective product ground truth label including only a plurality of weighted defect type labels indicating a possibility of correspondence to a plurality of defect types to a learning image of the defective product are used.

When performing prediction from the learning image by using the training data configured as described above, a loss value in a case of prediction as the normal product from a learning image of the defective product to which the defective product ground truth label is assigned becomes larger than a loss value in a case of prediction as the defective product in a defect type other than a ground truth from the same learning image. Since the prediction model is machine-learned to minimize the loss value, it is possible to further reduce a possibility of erroneously predicting the defective product as the normal product. Therefore, according to this embodiment, in the defect inspection device that performs defect inspection by using the prediction model generated by machine learning, it is possible to reduce false recognition of false negative in which the defective product is determined as the normal product as much as possible.

Note that, in the above embodiment, description has been given on the assumption that machine learning is performed by inputting the learning image of the training data to the prediction model, and prediction of presence or absence of a defect and a defect type is performed by applying the inspection image to the trained prediction model. On the other hand, but the prediction model may include a preprocessing unit that detects feature information from the input image.

In addition, the embodiment is a merely example of implementation of the invention, and the technical scope of the invention is not limited by the embodiment. That is, the invention can be implemented in various aspects without departing from the gist or main characteristics of the invention.

### REFERENCE SIGNS LIST

1: inspection image acquisition unit
2: product region extraction unit
3: prediction unit
10: prediction model storage unit
11: training data input unit
12: prediction model generation unit

1. A defect inspection device, comprising:
an inspection image acquisition unit that acquires an inspection image that is a captured image of an object to be inspected; and
a prediction unit that applies the inspection image acquired by the inspection image acquisition unit to a prediction model trained by using training data, and performs prediction whether the object to be inspected is a normal product, and prediction of a defect type in a case where the object to be inspected is a defective product,
wherein the training data is configured by assigning a normal product ground truth label that does not include a label indicating a possibility of correspondence to a defective product and includes only a normal label indicating a possibility of correspondence to a normal product to a learning image of the normal product, and by assigning a defective product ground truth label that does not include a normal label indicating a possibility of correspondence to the normal product and includes a plurality of defective type labels indicating a possibility of correspondence to a plurality of defect types, and a weight for each of the defect type labels to a learning image of a defective product.

2. The defect inspection device according to claim 1,
wherein the training data is configured by assigning a maximum weight to the normal label of the normal product ground truth label, and assigning a weight less than the maximum weight to each of the plurality of defect type labels of the defective product ground truth label.

3. A defect inspection method, comprising:
a first step of acquiring an inspection image that is a captured image of an object to be inspected by an inspection image acquisition unit of a computer; and
a second step of applying the inspection image acquired by the inspection image acquisition unit to a prediction model trained by using training data, and performing prediction whether the object to be inspected is a normal product, and prediction of a defect type in a case where the object to be inspected is a defective product by a prediction unit of the computer,
wherein the training data is configured by assigning a normal product ground truth label that does not include a label indicating a possibility of correspondence to a defective product and includes normal label indicating a possibility of correspondence to a normal product to a learning image of the normal product, and by assigning a defective product ground truth label that does not include a normal label indicating a possibility of correspondence to the normal product and includes a plurality of defective type labels indicating a possibility of correspondence to a plurality of defect types, and a weight for each of the defect type labels to a learning image of a defective product.

4. A prediction model generation method, comprising:
a first step of inputting training data to which a ground truth label is assigned by a training data input unit of a computer; and
a second step of performing machine learning processing by a prediction model generation unit of the computer by using the training data input by the training data input unit to generate a prediction model that outputs a prediction result as to whether an object to be inspected is a normal product, and a prediction result of a defect type in a case where the object to be inspected is a defective product when an inspection image that is a captured image of the object to be inspected is input,
wherein the training data is configured by assigning a normal product ground truth label that does not include a label indicating a possibility of correspondence to a defective product and includes only a normal label indicating a possibility of correspondence to a normal product to a learning image of the normal product, and by assigning a defective product ground truth label that does not include a normal label indicating a possibility of correspondence to the normal product and includes a plurality of defective type labels indicating a possibility of correspondence to a plurality of defect types, and a weight for each of the defect type labels to a learning image of a defective product.
